(19) United States
(12) Patent Application Publication
(10) Pub. No.: US 2026/0332780 A1
(43) Pub. Date: Oct. 22, 2026

(54) NON-LINEAR MODELING-BASED TEMPLATE MATCHING PREDICTION

(71) Applicants: Hyundai Motor Company, Seoul (KR); Kia Corporation, Seoul (KR); EWHA UNIVERSITY - INDUSTRY COLLABORATION FOUNDATION, Seoul (KR)

(72) Inventors: Je Won KANG, Seoul (KR); Jung Kyung LEE, Seoul (KR); Jung Ah CHOI, Seoul (KR); Jin HEO, Yongin-si, Gyeonggi-do (KR); Seung Wook PARK, Yongin-si, Gyeonggi-do (KR)

(73) Assignees: Hyundai Motor Company, Seoul (KR); Kia Corporation, Seoul (KR); EWHA UNIVERSITY - INDUSTRY COLLABORATION FOUNDATION, Seoul (KR)

(21) Appl. No.: 19/484,058

(22) PCT Filed: Apr. 4, 2024
(86) PCT No.: PCT/KR2024/004426

§ 371 Date: Nov. 13, 2025

(30) Foreign Application Priority Data
May 22, 2023 (KR) 10-2023-0065621
Apr. 3, 2024 (KR) 10-2024-0045374

(51) Int. Cl. H04N 19/159; H04N 19/117; H04N 19/176; H04N 19/186

(52) U.S. Cl. CPC H04N 19/159; H04N 19/117; H04N 19/176; H04N 19/186

(57) ABSTRACT

A method and an apparatus are disclosed for video using a non-linear modeling-based template matching prediction. In the disclosed embodiments, the video decoding apparatus searches for a reference block based on template matching between templates of blocks within a search region and a template of the current block, or based on a block vector of the current block, and determines a prediction block of the current block by using the searched reference block. The video decoding apparatus obtains a type of a filter for the current block. Here, the type of the filter comprises a cross-component discrete mapping model or a cross-component nonlinear filter. The video decoding apparatus calculates coefficients of the filter by using the reference block, and applies filtering to the prediction block by using the calculated filter.

### TECHNICAL FIELD

The present disclosure relates to a video coding method and an apparatus using selective multiple syntaxes.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

In encoding/decoding using template matching-based prediction, the reference block corresponding to a template most similar to the current block's template is used as the matching block. During template matching-based decoding, the decoder searches for the matching block based on template matching between the reference blocks' templates and the current block's template, and determines the prediction block of the current block with the searched matching block. The decoder uses sum of absolute differences (SAD) or sum squared errors (SSE) to calculate similarity based on template matching. Since template matching is performed by using multiple reconstructed reference blocks, the template matching-based prediction increases the computational complexity of the video decoding process. To reduce computational complexity, template matching is performed by defining a search region for locating the reference block. As illustrated in FIGS. 6, R1, R2, R3, and R4 correspond to the search regions for template search.

Meanwhile, filtering may be applied to intra template matching prediction (intraTMP). A filter is applied to the reference block, and the filtered reference block is used as the prediction block of the current block. For example, the filter is a 6-tap linear filter that includes five luma taps and one bias term. The filter coefficients are derived per block by using a regression model that minimizes the mean square error (MSE) between the filter output generated by the reference template and the samples of the current template. A filter flag indicating the use or nonuse of the linear filter is transmitted at the CU level from the encoder to the decoder. Furthermore, the use of the linear filter is considered a lower-level mode of intra template matching prediction. When the template matching flag indicating the use or nonuse of intra template matching prediction is true, the filter flag is signaled. Meanwhile, to increase video coding efficiency and enhance video quality, there is a need for a method of utilizing a nonlinear model in the aforementioned filtering process.

### DISCLOSURE

### Technical Problem

The present disclosure seeks to provide a video coding method and an apparatus that, when performing template matching prediction (TMP), utilize a discrete mapping model-based template matching technique or a nonlinear filter-based template matching technique. The video coding method and the apparatus utilize a cross-component discrete mapping model or a cross-component nonlinear model based on a template matching technique.

### Technical Solution

At least one aspect of the present disclosure provides a method for reconstructing a current block by a video decoding apparatus. The method includes searching for a reference block based on template matching between templates of blocks within a search region and a template of the current block, or based on a block vector of the current block. The method also includes determining a prediction block of the current block by using the searched reference block. The method also includes obtaining a type of a filter for the current block. Here, the type of the filter comprises a cross-component discrete mapping model or a cross-component nonlinear filter. The method also includes calculating coefficients of the filter by using the reference block. The method also includes applying filtering to the prediction block by using the filter.

Another aspect of the present disclosure provides a method for encoding a current block by a video encoding apparatus. The method includes generating a first prediction block of the current block by using a prediction mode other than template matching and an intra block copy mode (IBC mode). The method also includes searching for a reference block based on template matching between templates of blocks within a search region and a template of the current block, or based on a block vector of the current block, and determining a second prediction block of the current block by using the searched reference block. The method also includes obtaining a type of a filter for the current block. Here, the type of the filter comprising a cross-component discrete mapping model or a cross-component nonlinear filter. The method also includes calculating coefficients of the filter by using the reference block. The method also includes generating a filtered second prediction block by applying filtering to the second prediction block by using the filter.

Yet another aspect of the present disclosure provides a method for providing video data to a video decoding apparatus. The method includes encoding the video data into a bitstream, and transmitting the bitstream to the video decoding apparatus. The encoding of the video data includes generating a first prediction block of a current block by using a prediction mode other than template matching and an intra block copy mode (IBC mode). The encoding of the video data also includes searching for a reference block based on template matching between templates of blocks within a search region and a template of the current block, or based on a block vector of the current block, and determining a second prediction block of the current block by using the searched reference block. The encoding of the video data also includes obtaining a type of a filter for the current block. Here, the type of the filter comprising a cross-component discrete mapping model or a cross-component nonlinear filter. The encoding of the video data also includes calculating coefficients of the filter by using the reference block. The encoding of the video data also includes generating a filtered second prediction block by applying filtering to the second prediction block by using the filter.

### Advantageous Effects

As described above, the present disclosure provides a video coding method and an apparatus that, when performing template matching prediction, utilize a discrete mapping model-based template matching technique or a nonlinear filter-based template matching technique. The video coding method and the apparatus utilize a cross-component discrete mapping model or a cross-component nonlinear model based on a template matching technique. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating a search region for template searching, according to at least one embodiment of the present disclosure.

FIG. 7 is a flowchart of a reconstruction of a current block by a video decoding apparatus, according to at least one embodiment of the present disclosure.

FIG. 8 is a diagram illustrating a filter for filtering a prediction block based on template matching, according to at least one embodiment of the present disclosure.

FIG. 9 is a diagram illustrating the multi-model linear model mode (MMLM mode).

FIG. 10 is a diagram illustrating the Decoder-side Intra Mode Derivation (DIMD) chroma mode.

FIG. 11 is a diagram illustrating a reference region used for deriving filter coefficients.

FIG. 12 is a diagram illustrating Sobel filters for gradient calculation.

FIG. 13 is a diagram illustrating candidate luma blocks in direct block vector mode (DBV mode).

FIG. 14 is a diagram illustrating the prediction of a chroma block in the DBV mode.

FIG. 15 is a diagram illustrating co-located luma sample values resulting from the application of candidate downsampling filters.

FIG. 16 is a diagram illustrating nonlinear modeling-based template matching prediction according to at least one embodiment of the present disclosure.

FIG. 17 is a diagram illustrating the sequence for checking luma samples in a discrete mapping model, according to at least one embodiment of the present disclosure.

FIG. 18 is a diagram illustrating a nonlinear filter of an adaptive loop filter (ALF) shape, according to at least one embodiment of the present disclosure.

FIG. 19 is a diagram illustrating nonlinear modeling-based template matching prediction according to another embodiment of the present disclosure.

FIG. 20 is a flowchart of a method of encoding the current block by a video encoding apparatus, according to at least one embodiment of the present disclosure.

FIG. 21 is a flowchart of a method of reconstructing the current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

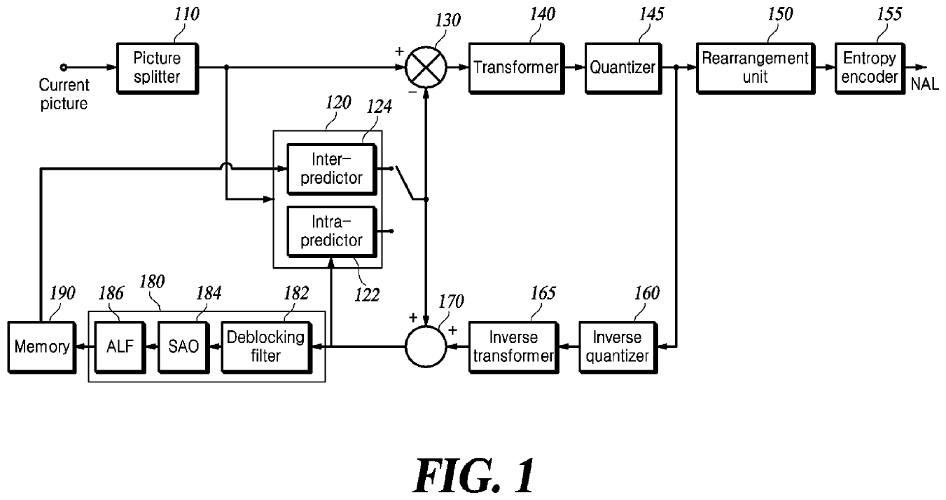

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU).

Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

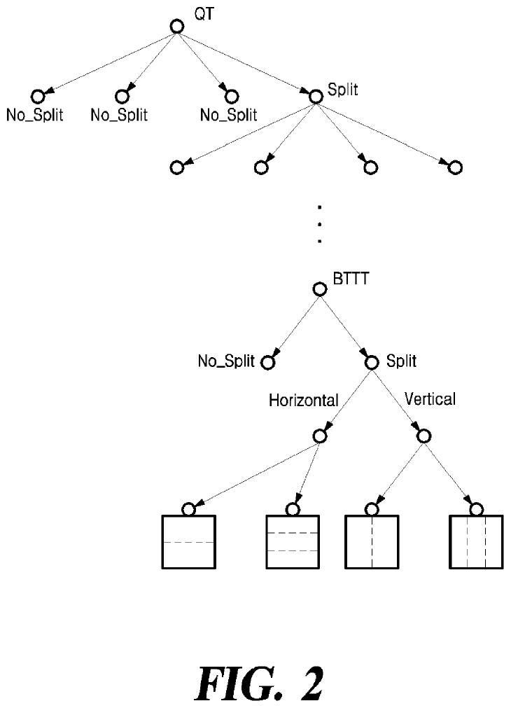

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

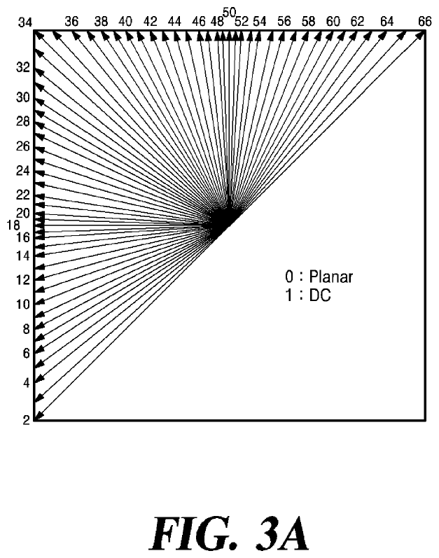

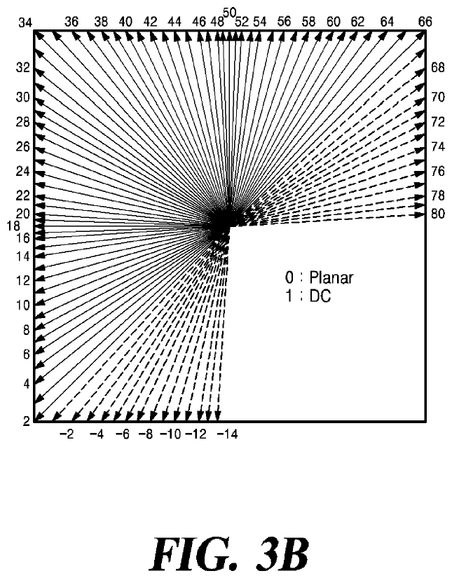

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component.

Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus.

Such a method is referred to as a merge mode.

In the merge mode, the inter predictor 124 selects a predetermined number of merge candidate blocks (hereinafter, referred to as a “merge candidate”) from the neighboring blocks of the current block.

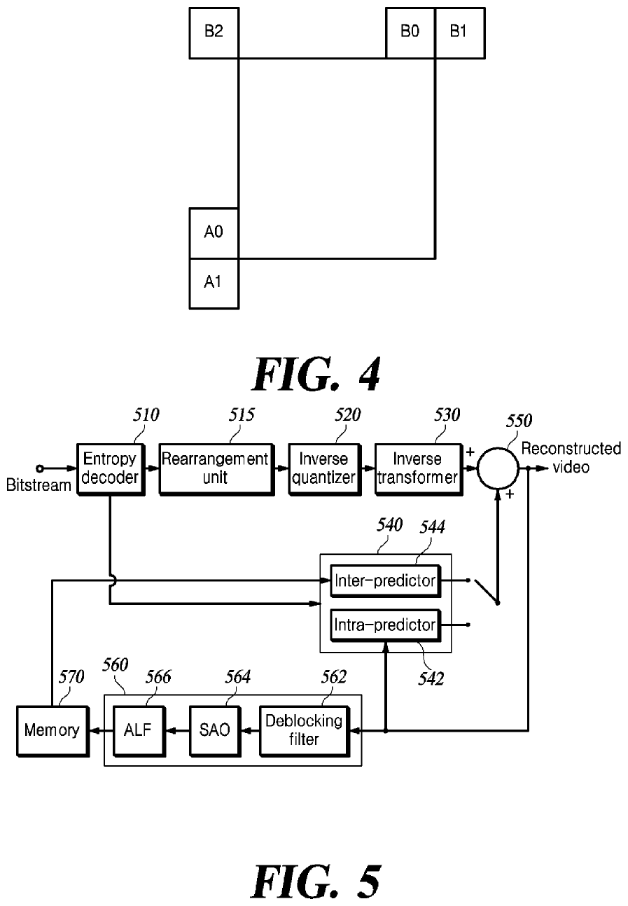

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a ID coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that, when performing template matching prediction, utilize a discrete mapping model-based template matching technique or a nonlinear filter-based template matching technique. The video coding method and the apparatus utilize a cross-component discrete mapping model or a cross-component nonlinear model based on a template matching technique.

The following embodiments may be performed by the intra predictor 122 in the video encoding device. The following embodiments may also be performed by the intra predictor 542 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Template Matching-Based Prediction

In encoding/decoding using a template matching-based prediction, one uses as a matching block a reference block corresponding to a template most similar to the current block's template. In template matching-based decoding, the video decoding apparatus searches for a matching block based on the template matching between the reference blocks' templates and the current block's template, and determines the prediction block of the current block as the searched matching block. In other words, the matching block represents the reference block (selected) according to template matching. Hereafter, the reference block′ template is used interchangeably with the reference template, and the current block′ template is used interchangeably with the current template.

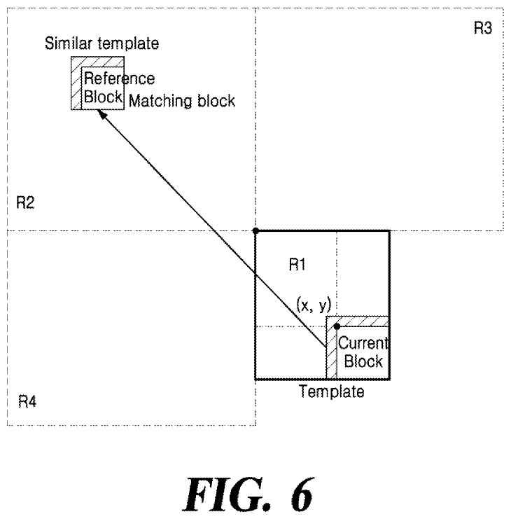

The video decoding apparatus uses a measure such as sum of absolute differences (SAD), sum of squared errors (SSE), and the like to calculate the similarity based on template matching. Since template matching is performed by using multiple reconstructed reference blocks, template matching-based prediction increases the computational complexity of the video decoding process. To reduce the computational complexity, template matching is performed by defining a search region to search for reference blocks. As illustrated in FIGS. 6, R1, R2, R3, and R4 correspond to the search regions for template search. In the example of FIG. 6, (x,y) denotes the position of the top left sample of the current block.

Hereinafter, a mode for predicting the current block based on template matching is referred to as a template matching-based prediction mode. Additionally, a method of intra predicting the current block by using the template matching-based prediction mode is referred to as template matching-based intra prediction or intra-template matching prediction (intraTMP). Hereafter, template matching-based intra prediction and template matching-based prediction are used interchangeably. Template matching and intra-template matching are used interchangeably.

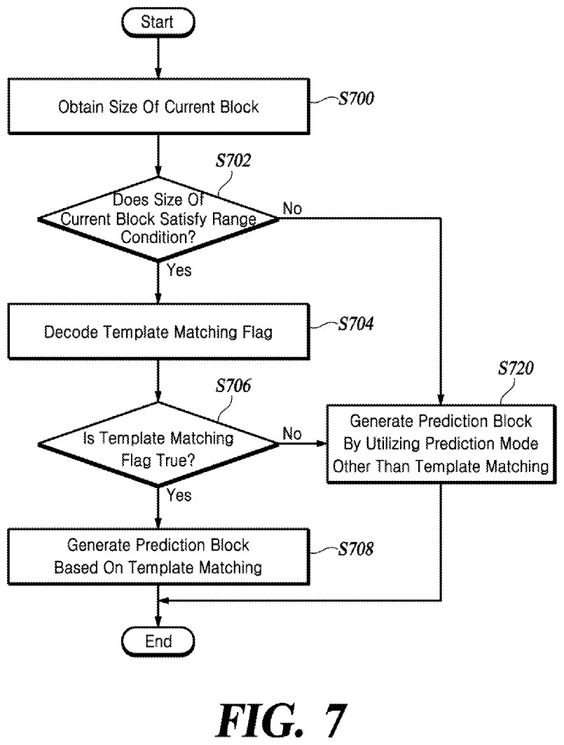

Referring now to FIG. 7, a method for predicting and reconstructing a current block by using a template matching-based prediction mode is described.

FIG. 7 is a flowchart of a reconstruction of a current block performed by the video decoding apparatus, according to at least one embodiment of the present disclosure.

The video decoding apparatus obtains the size of the current block (S700).

The video decoding apparatus determines whether the size of the current block satisfies a range condition (S702). The video decoding apparatus determines whether the size of the current block satisfies a range condition for decoding based on the template matching-based prediction. For example, the range condition refers to a minimum size condition of the current block and/or a maximum size condition of the current block. Depending on whether the range condition is satisfied, the reconstruction process is divided into a reconstruction process that utilizes template matching and a reconstruction process that does not utilize template matching.

If the range condition is satisfied (Yes in S702), the video decoding apparatus decodes a template matching flag (S704). The template matching flag indicates whether intra-template matching is to be used for the current block.

The video decoding apparatus checks the template matching flag (S706).

If the template matching flag is true (Yes in S706), the video decoding apparatus generates a prediction block of the current block based on the template matching (S708).

If the range condition is not satisfied (No in S702) or the template matching flag is false (No in S706), the video decoding apparatus generates the prediction block of the current block by utilizing a prediction mode that does not use template matching (S720). For example, the video decoding apparatus may utilize an intra-prediction mode that does not use template matching, or may utilize an inter-prediction mode.

The video decoding apparatus may then decode the residual block and may sum the residual block and the prediction block to generate a reconstructed block of the current block.

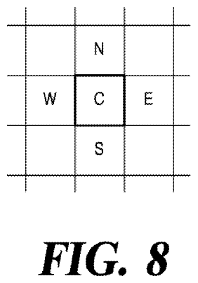

Meanwhile, filtering may be applied to the intra-template matching prediction. The filter is applied to a matching block, and the resultantly filtered matching block is utilized as the prediction block of the current block. For example, the filter is a 6-tap linear filter that is cross-shaped with five luma taps and one bias term. As illustrated in FIG. 8, the input to the spatial 5-tap component of the filter is composed of the matching block's center (C) sample, top/north (N) sample, bottom/south(S) sample, left/west (W) sample, and right/east (E) sample at locations corresponding to the samples of the current block. Hereinafter, the 6-tap filter is also referred to as a 5-tap filter without considering the bias term.

The output of the filter is calculated as shown in Equation 1.

predLumaVal=c0C+c1N+c2S+c3E+c4W+c5B [Equation 1]

In Equation 1, B denotes the bias term.

The filter coefficients c0 to c5 shown in Equation 1 are derived for each block by using a regression model that minimizes the mean square error (MSE) between the output of the filter and the samples in the current block's template. MSE minimization includes calculation of an autocorrelation matrix between the reference template and the current template, LDL decomposition of the autocorrelation matrix, and calculation of filter coefficients by back-substitution.

A filter flag, which indicates whether the filter is to be used, is sent from the video encoding apparatus to the video decoding apparatus at the CU level. Furthermore, the use of the linear filter is considered a sub-mode of the intra-template matching prediction. For example, if a template matching flag, which indicates whether the intra-template matching prediction is to be used, is true, the filter flag is signaled.

### II. Chroma Prediction Mode of Enhanced Compression Model (ECM)

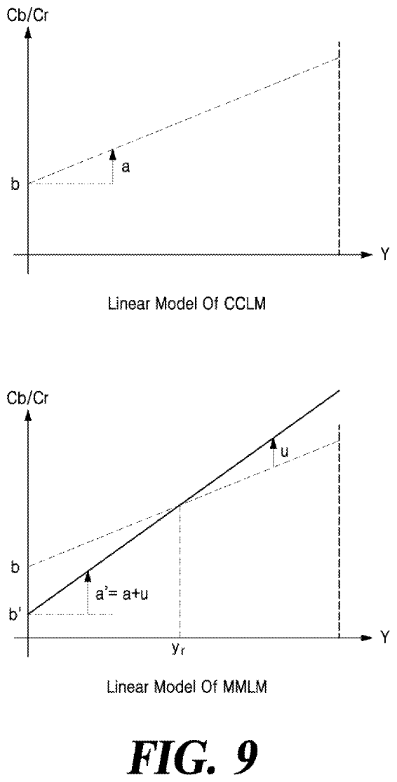

In the ECM corresponding to Beyond VVC (versatile video coding), a multi-model LM mode (MMLM mode) is added, which is an extension of the cross-component linear model (CCLM) included in the existing VVC. The MMLM mode derives a linear model by applying the least mean square (LMS) method to luma samples and improves accuracy by adjusting the gradient of the linear model. As illustrated in FIG. 9, gradient adjustment is performed by using a linear function that maps luma values to chroma values based on a center point determined by the average luma value of the reference sample. The linear function of MMLM mode is derived from the linear function of CCLM mode as shown in Equation 2.

chromaVal=a′·lumaVal+b′

a′=a+u,b′=b−u·yᵣ [Equation 2]

In Equation 2, a and b are parameters representing the linear model of the CCLM mode illustrated in FIG. 9, while a′ and b′ are parameters representing the linear function of the MMLM mode. yr denotes the reference luma sample value corresponding to the center point.

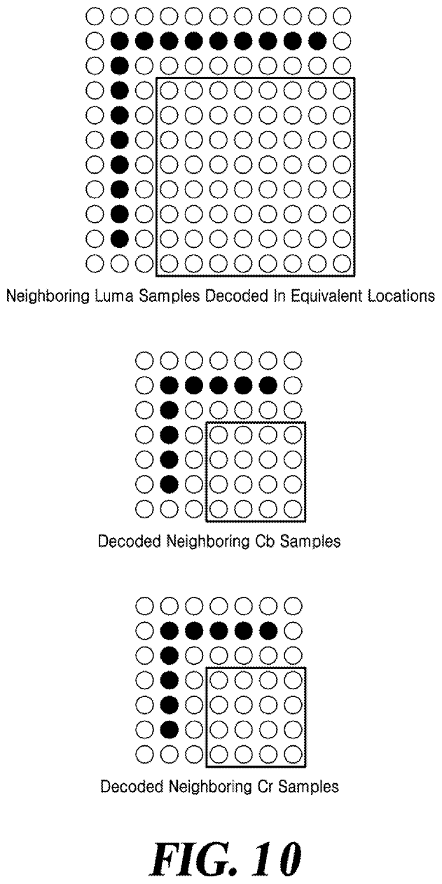

A decoder-side intra mode derivation chroma (DIMD chroma) determines the intra prediction mode of the current chroma block. As illustrated in FIG. 10, the DIMD chroma mode is used based on the neighboring luma samples and chroma samples decoded from the neighboring rows and columns. With horizontal and vertical gradient calculations performed on the luma samples, Cb and Cr samples decoded at the same position in the current chroma block, a histogram of gradient is calculated. The prediction mode with the largest histogram value is used for intra prediction of the current chroma block. If the intra-prediction mode derived according to the DIMD chroma mode is identical to the intra-prediction mode according to the DM mode, the intra-prediction mode with the second largest histogram value is used for the intra prediction of the current chroma block. A CU-level flag may be signaled to indicate the applicability of the DIMD chroma mode.

In ECM, two chroma prediction blocks may be fused together to generate the final predicted signals as shown in Equation 3.

pred_{C}(i,j)=(w0×pred0(i,j)+w1×pred1(i,j)+(1<<(shift−1)))>>shift [Equation 3]

In Equation 3, one of the two chroma prediction blocks is generated according to either the derived mode (DM), DIMD chroma mode, or one of the four basic modes (non-LM modes). The other prediction block may be generated according to the cross-component linear prediction mode. For example, pred0(i,j) may be predicted according to the non-linear model mode (non-LM mode), and pred1(i,j) may be predicted according to the MMLM_LT mode. The four basic modes represent DC mode, planar mode, horizontal mode (No. 18), and vertical mode (No. 50). The MMLM_LT mode represents the MMLM mode that utilizes left and top samples to derive the linear model.

In Equation 3, the weights w0 and w1 are determined based on the intra-prediction mode of the adjacent chroma block, and the shift is set to 2. When both the top and left adjacent blocks are encoded in LM mode, {w0, w1}={1, 3}. When neither the top nor left adjacent blocks are encoded in LM mode, {w0, w1}={3, 1}. In all other cases, {w0, w1}= {2, 2}.

As another example, the final predicted signals may be generated as shown in Equation 4.

$${pred}_{C} ( i , j ) = {α}_{0} \times pred 0 ( i , j ) + {α}_{1} \times {rec}_{L}^{′} ( i , j ) + {α}_{2} \times β \qquad [ Equation 4 ]$$

In Equation 4, pred0(i,j) is predicted according to the non-LM mode, and rec′L(i,j) represents the downsampled co-located luma sample.

The convolutional cross-component model mode (CCCM mode) predicts chroma samples from reconstructed luma samples, similar to the CCLM mode. When chroma subsampling is used, the CCCM mode downsamples the luma samples to align their positions with the chroma samples and thereby compensates for the resolution difference between luma samples and chroma samples. CCCM mode calculates the model by using top, left, or top-left reference samples.

The 7-tap convolutional filter in CCCM mode is composed of a 5-tap cross-shaped spatial component, a nonlinear term, and a bias term. The 5-tap component of the filter may be represented as illustrated in FIG. 8. For example, the 5-tap component of the filter is composed of the central (C) luma sample, the down/south(S), left/west (W), right/east (E), and up/north (N) samples.

The nonlinear term P is expressed as a power of the central luma sample C, as shown in Equation 5, and is scaled by the bit depth.

P=(C·C+midVal)>>bitDepth [Equation 5]

For images with 10-bit depth, the nonlinear term P is expressed as in Equation 6.

P=(C·C+512)>>10 [Equation 6]

The bias term B represents a scalar offset between the input and output, and is the mid-chroma value that is 512 for images with 10-bit depth. The output of the convolution filter is calculated as the convolution between the filter coefficient cᵢ and the input value, and is clipped to the valid range of chroma samples. The convolution filter finally calculates the predicted value as shown in Equation 7.

predChromaVal=c0C+c1N+c2S+c3E+c4W+c5P+c6B [Equation 7]

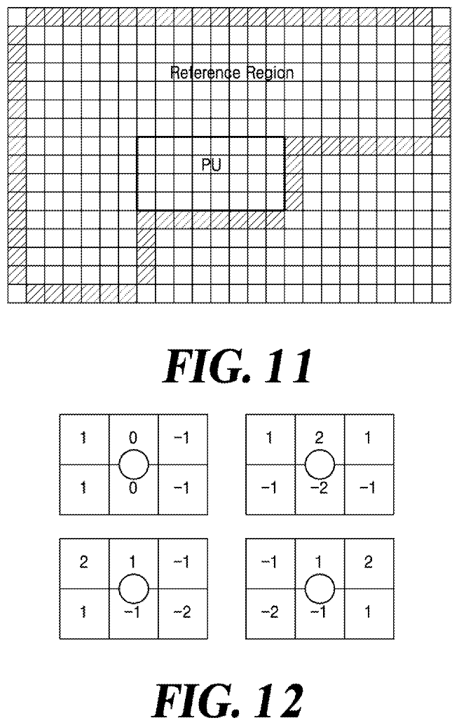

The filter coefficient cᵢ is calculated to minimize the mean square error (MSE) between the predicted chroma sample and the reconstructed chroma sample within the reference region. In the example of FIG. 11, the six lines positioned at the top and left of the prediction unit (PU) represent the reference region of the chroma sample. The reference region is expanded toward the bottom-left and top-right of the border of the PU by an area equal to the width and height of the PU, respectively. The hatched area around the reference region and prediction unit may be used to derive a cross-shaped spatial filter, and unusable areas may be padded to be usable.

MSE minimization is computed by using the autocorrelation matrix for the luma sample and the cross-correlation vector between the luma input and chroma output. The autocorrelation matrix undergoes LDL decomposition, and the final filter coefficients are computed via back-substitution. MSE minimization roughly follows the process of calculating ALF filter coefficients in ECM. However, LDL decomposition is used instead of Cholesky decomposition to avoid square root operations.

A gradient linear model (GLM) when in the YUV 4:2:0 color format is used to predict the chroma sample from the luma sample gradient. A GLM mode uses either two or three variables. When using two variables, the GLM utilizes the luma sample gradient to derive a linear model. In this case, the derivation method for the CCLM parameters and the linear transform of the predicted sample remain unchanged and are used in its original form. In the GLM using two variables, the chroma sample C is expressed as in Equation 8.

C=α·G+β [Equation 8]

In Equation 8, α and β represent the linear model's parameters derived according to the CCLM mode, and G denotes the gradient.

The GLM mode using three variables predicts the chroma sample based on the luma sample gradient and the downsampled luma value. The model parameters for the 3-variables GLM are derived by using the rows and columns of the adjacent six samples, based on the LDL decomposition-based MSE minimization method used in CCCM. In the 3-variables GLM, the chroma sample C is expressed as in Equation 9.

C=α₀·G+α₁·L+α₂·β [Equation 9]

In Equation 9, G and L represent the luma sample gradient and the downsampled luma value, respectively, while α₀, α₁, and β denote the parameters of the GLM model.

From a signaling perspective, when the CCLM mode is enabled with the current CU, the present disclosure signals a flag indicating whether the GLM is to be enabled for both the Cb and Cr components. When the GLM is enabled, another flag indicating one of the two GLM modes is signaled. Additionally, as illustrated in FIG. 12, the present disclosure also signals a filter index indicating one of the four Sobel filters for gradient calculation. In the example of FIG. 12, the circle at the center of each filter indicates the position of the chroma sample corresponding to the six luma samples.

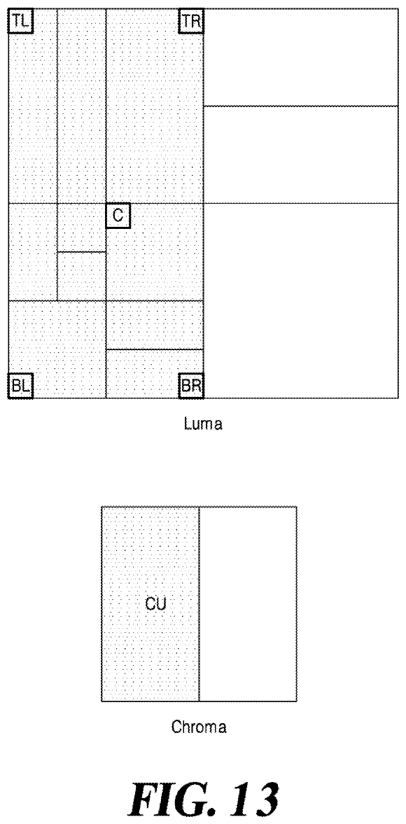

Direct block vector mode (DBV mode) is used for the chroma block in dual tree slices. When dual tree is enabled, a flag is displayed indicating whether the chroma block was encoded by using intra block copy (IBC) mode. When DBV mode is enabled, the chroma block's position and the candidate luma blocks' positions correspond to those illustrated in FIG. 13. In FIG. 13, the candidate luma blocks are located in the chroma block's corresponding luma region at the center, top left, top right, bottom left, and bottom right. When one of the five candidate luma blocks corresponding to the chroma block encoded in DBV mode is encoded in IBC mode or intraTMP mode, the one luma block's block vector Luma (bvL) is used to derive the chroma block's block vector Chroma (bvC). The luma block's block vector is resized and used as the chroma block's block vector. When template matching is used for block vector scaling and the luma block is encoded by using reconstruction reordered IBC (RR-IBC), horizontal or vertical block vector (BV) adjustment is performed on the bvL in the same manner as RR-IBC.

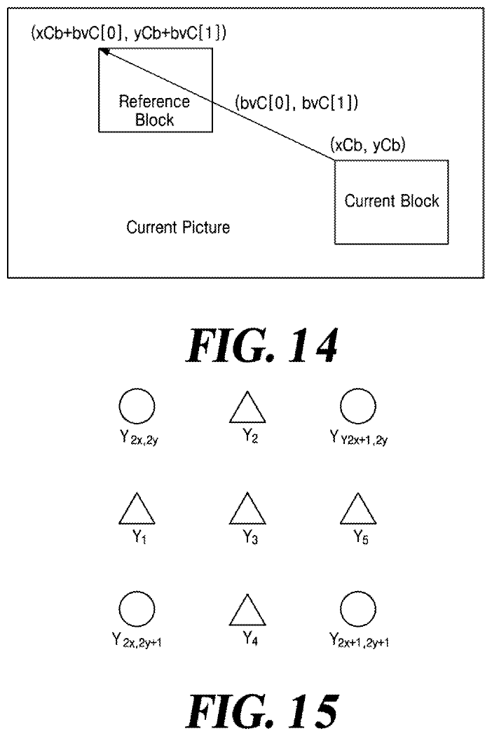

As illustrated in FIG. 14, the DBV mode uses the positions of the current chroma block (xCb, yCb) and bvC to determine the corresponding offset position (xCb+bvC[0], yCb+bvC[1]), and predicts the chroma block.

Compared to natural video for which linear filters operate effectively, screen content coding attempts to enhance coding efficiency by employing a discrete model. The cross-component discrete mapping model (CCDMM) memorizes pairs of luma and chroma values from reconstructed neighboring samples and derives a discrete mapping that maps based on the memorized pairs, in contrast to the CCLM mode which uses a continuous linear model. The CCDMM mode uses the memorized pairs to predict chroma samples from co-located luma samples. In the pair of luma and chroma values, the luma value corresponds to the input, and the chroma value corresponds to the output. Hereafter, the set of pairs of luma and chroma values is defined as the mapping set of the discrete mapping model, or the discrete mapping set.

The CCDMM mode uses the decoded region to derive the mapping function between luma and chroma. Compared to the continuous models of CCLM mode or CCCM mode, the discrete mapping model of CCDMM mode directly stores luma-chroma pairs without a continuous function. To predict the chroma sample in the current chroma block, the CCDMM mode references the co-located luma value Yc to derive the chroma prediction value according to the discrete mapping model. When the input to a mapping set of the discrete mapping model has no searchable Y_{c}, the CCDMM mode checks the luma-chroma pairs in the order {Y_{c+1}, Y_{c-1}, Y_{c+2}, Y_{c-2}} as illustrated in FIG. 17. In the example of FIG. 17, c=3, meaning Y_{c}=Y₃. If none of the five values match any input to the discrete mapping set, the CCDMM mode predicts the chroma sample by calculating the average of adjacent reconstructed chroma samples.

For example, to generate optimal co-located luma sample values for the YCbCr 4:2:0 color format, five candidate downsampling filters are introduced as illustrated in FIG. 15. In the example of FIG. 15, the circles represent luma samples, and the triangles (Y₁ to Y₅) represent the co-located luma sample values resulting from applying the candidate downsampling filters. The video encoding apparatus uses the candidate downsampling filters for generating co-located luma sample values to select the index of the optimal filter. Following a method similar to GLM, the video encoding apparatus signals the selected index to the video decoding apparatus.

The following embodiments are described with a focus on the video decoding apparatus, but they may be implemented in the same or similar manner in the video encoding apparatus.

Hereinafter, in the description related to the process following template matching, the matching block that is the reference block selected according to template matching may be used interchangeably with the reference block. Therefore, the reference template may represent the template of the matching block. Furthermore, hereinafter, in the description related to the application of the IBC mode, the matching block that is the reference block selected by the block vector may be used interchangeably with the reference block.

### III. Embodiments According to the Present Disclosure

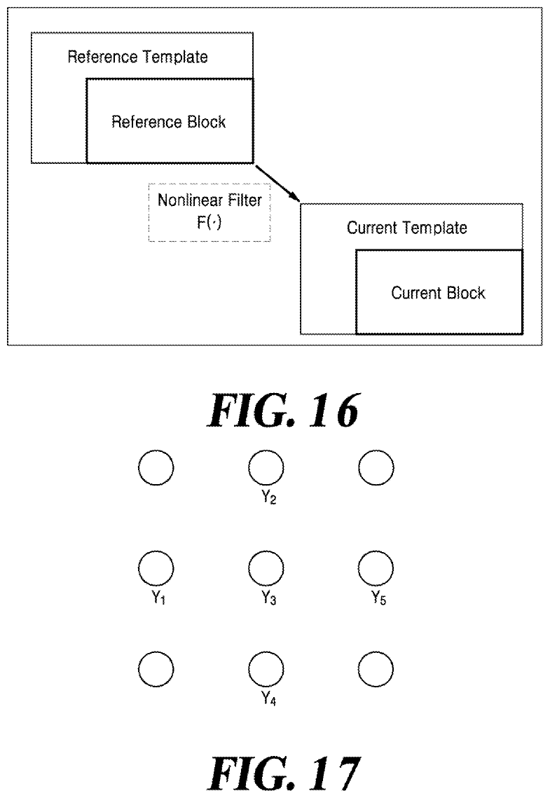

FIG. 16 is a diagram illustrating nonlinear modeling-based template matching prediction according to at least one embodiment of the present disclosure.

As illustrated in FIG. 16, the video decoding apparatus according to the present disclosure uses a current template and a reference template to derive a nonlinear model, and uses the derived model for filtering a reference block to generate a final current block. The following describes in sequence (Implementation 1) Template matching technique based on discrete mapping model, (Implementation 2) Template matching technique based on a nonlinear filter, (Implementation 3) Cross-component discrete mapping model based on the template matching technique, and (Implementation 4) Cross-component nonlinear model based on the template matching technique. The present disclosure may be applicable to special video compression exclusively, such as screen content. In that it is not a linear filter, the discrete mapping model may be included in nonlinear filters.

### (Implementation 1) Template Matching Technique Based on Discrete Mapping Model

This implementation describes a template matching technique utilizing a discrete mapping model. The video decoding apparatus derives a discrete mapping model between the current block's template and the reference block's template, and applies the derived model to the reference block to generate the current block.

The video decoding apparatus directly stores luma pairs between the reference template and the current template to derive the discrete mapping model, due to lack of calculation of continuous functions such as linear functions. Namely, the discrete mapping model is implemented as a nonlinear filter. The video decoding apparatus according to the present disclosure derives a discrete mapping model by storing luma pairs representing the luma signal relationship between the luma signals of the current block's template and the template of the reference block in the decoded region. This replaces the conventional CCDMM technique of deriving the discrete mapping model by storing the mapping relationship between the luma signal and the co-located chroma signal. In the luma pair, the luma value of the reference template/reference block is equivalent to the input, and the luma value of the current template/current block is equivalent to the output. Hereinafter, the set containing luma pairs is defined as the discrete mapping model's mapping set, or simply the discrete mapping set.

The video decoding apparatus is to predict the sample of the current block by deriving a predicted value from the luma value of the reference block, based on the pre-derived discrete mapping model. When deriving the predicted value, the video decoding apparatus may select one of the following methods.

For example, the video decoding apparatus is to predict the samples of the current block by applying the derived discrete mapping model to the samples of the reference block. For instance, the video decoding apparatus derives the predicted value of the current block from the luma value Y_{c} of the reference block at the common position with the current block, based on the discrete mapping model. When the input to the discrete mapping set has no searchable Y_{c}, the video decoding apparatus either uses Y_{c} that is the prediction value as is without applying discrete mapping or uses the value most similar to Y_{c} as the prediction value. The video decoding apparatus uses an arbitrary value (e.g., a median value based on bit depth) as the prediction value or as input to the discrete mapping set. Alternatively, the video decoding apparatus uses, among the most adjacent reconstructed luma samples, a luma sample with an applicable value for mapping as an input to the discrete mapping set.

As another example, when the input to the discrete mapping set has no searchable values of the five samples {Y_{c}, Y_{c+1}, Y_{c-1}, Y_{c+2}, Y_{c-2}} as illustrated in FIG. 17, the video decoding apparatus generates as a predicted value the adjacent luma samples' average, median, or a predefined weighted sum. Alternatively, the video decoding apparatus may use the adjacent luma samples' average value, median value, or a predefined weighted sum as the input to the discrete mapping set. Yet alternatively, the video decoding apparatus may generate a preset value as the predicted value. In the example of FIG. 17, it is applicable that c=3, i.e., Y_{c}=Y₃. The preset weighted sum represents a predefined weighted sum where the number of samples subject to the weighted sum and the relevant weights are predetermined.

As yet another example, when the input to the discrete mapping set has no searchable Y_{c}, the video decoding apparatus generates a predicted value by interpolating a preset number of luma samples adjacent to Y_{c}.

Implementation 1 relates to the method of establishing a discrete mapping model between the current block's luma signals and the reference block's luma signals during the template matching process. Meanwhile, Implementation 1 may also be applied between the current block's chroma signals and the reference block's chroma signals.

Implementation 1 relates to a method of establishing a discrete mapping model during the template matching process between the current block's luma signals and the reference block's luma signals, and between the current block's chroma signals and the reference block's chroma signals. When Implementation 1 is applied to the IBC mode of a single tree, the reference block may be obtained based on an existing block vector rather than being obtained during the template matching process. Furthermore, when Implementation 1 is applied to the IBC mode of a dual tree, the chroma component reference block may be obtained based on the chroma block vector derived from the direct block vector mode (DBV mode). Subsequently, the video decoding apparatus uses the current template and reference block's template to derive the luma signal relations, and if applicable to the chroma component, the chroma signal relations.

### (Implementation 2) Template Matching Technique Based on a Nonlinear Filter

This implementation describes a template matching technique utilizing a nonlinear filter. The video decoding apparatus derives a nonlinear model between the current block's template and the reference block's template, and applies the derived model to the reference block to predict the current block. Here, the existing nonlinear model derivation techniques like GLM or CCCM would have derived the mapping relationship between the luma signal and the co-located chroma signal as a nonlinear function. Instead, the video decoding apparatus according to the present disclosure derives within the decoded region a nonlinear model representing the relationship between the luma signals of the current block's template and reference block's template and stores the derived nonlinear model.

In addition to the derivation methods used in existing GLM, CCCM, and the like, the video decoding apparatus uses one of the following representation schemes, a part of the one representation scheme, or a combination of the representation schemes to implement the nonlinear filter.

To predict the luma sample, the nonlinear filter according to this embodiment may be implemented as shown in Equation 10.

$${Y}_{c} ( x , y ) = {\sum }_{( {x}_{0} , {y}_{0} ) ∈ {S}_{i}} \{ NM of {Y}_{r} ( {x}_{r} + {x}_{0} , {y}_{r} + {y}_{0} ) \} {c}_{i} ( {x}_{0} , {y}_{0} ) \qquad [ Equation 10 ]$$

In Equation 10, Y_{c} represents the luma sample of the current template or current block, and Yᵣ represents the luma sample of the reference block or reference template. (x, y) denotes the position of the current sample, and (x_{c}, y_{c}) denotes the position of the reference sample corresponding to (x, y). (x₀, y₀) represents the filter offset neighboring (x_{c}, y_{c}), and Si represents the target region for filtering for the reference samples. The filter offset may be adjusted by using the block vector used in the luma block co-located or using the DBV for the chroma block.

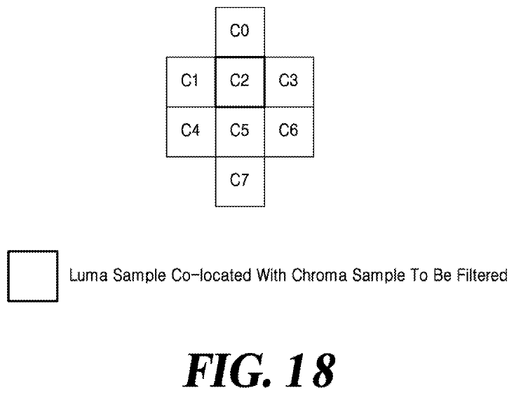

cᵢ(x₀, y₀) represents the filter coefficient. The shape of the filter may vary with various sizes. One example may use a filter of the same shape as the ALF filter illustrated in FIG. 18. Another example may use a filter of the shape illustrated in FIG. 8. Yet another example may use the nonlinear filter including linear terms as shown in Equation 7, in addition to the nonlinear terms shown in Equation 10.

The nonlinear filter uses nonlinear modeling (NM) for luma samples within the target region for filtering, to generate nonlinear modeling values. Subsequently, the nonlinear filter may generate a luma sample value based on the product of the nonlinear modeling values and nonlinear filter coefficients.

At this time, one of the following schemes may be used for nonlinear modeling.

As one example, a nonlinear model may be implemented by using a polynomial function, as shown in Equation 11.

NM=αₙ·(Yᵣ(xᵣ+x₀,yᵣ+y₀)ⁿ+αₙ₋₁·(Yᵣ(xᵣ+x₀,yᵣ+y₀)ⁿ⁻¹+ . . . +α₁·(Yᵣ(xᵣ+x₀,yᵣ+y₀))+α₀ [Equation 11]

Another example may use the Michaelis-Menten hyperbolic model as shown in Equation 12.

$$NM = \frac{{Y}_{r} ( {x}_{r} + {x}_{0} , {y}_{r} + {y}_{0} ) + {α}_{0}}{1 + {α}_{1} + {Y}_{r} ( {x}_{r} + {x}_{0} , {y}_{r} + {y}_{0} )} \qquad [ Equation 12 ]$$

Yet another example may use a model based on the Fourier transform as shown in Equation 13.

NM=α₁ cos(Yᵣ(xᵣ+x₀,yᵣ+y₀)+α₀) [Equation 13]

Yet another example may use an exponential function model as shown in Equation 14.

NM=e^{Y}^{ᵣ}^{(x}^{ᵣ}^{+x}^{₀}^{,y}^{ᵣ}^{+y}^{₀})+α₀ [Equation 14]

In Equations 11 through 14, Yᵣ denotes the luma sample of the reference block or reference template. (x_{c}, y_{c}) denotes the reference sample′ position corresponding to the current sample's position (x, y). (x₀, y₀) represents the filter offset neighboring (x_{c}, y_{c}). Furthermore, αⱼ are parameters of the nonlinear model and may be preset values according to the nonlinear model. For example, if the nonlinear model is a polynomial function as in Equation 6, α₂ is 1 and α₀ is 512.

As an example, the video decoding apparatus sets Y_{c} and Yᵣ as the current template and reference template, respectively, in the presented nonlinear modeling. It then calculates the filter coefficients so as to minimize the MSE between the predicted value according to Equation 10 and the reconstructed value of the current template. After deriving the nonlinear filter coefficients, the video decoding apparatus predicts the current block based on the derived nonlinear filter. By referencing the luma value which is in the reference block Yᵣ and co-located with the current block Y_{c}, the video decoding apparatus calculates the finally predicted Y_{c} based on the nonlinear filter.

Implementation 2 relates to the method of establishing a nonlinear relationship between the current block's luma signals and those of the reference block′ luma signals during the template matching process. Meanwhile, Implementation 2 may also be applied between the current block's chroma signals and the reference block's chroma signals.

Implementation 2 relates to a method of establishing nonlinear relationships between the current block's luma signals and the reference block's luma signals, and between the current block's chroma signals and the reference block's chroma signals, and it utilizes template matching in the process of obtaining the reference block. When Implementation 2 is applied to the IBC mode of a single tree, obtaining the reference block can be done based on the existing block vector in addition to using template matching. When Implementation 2 is applied to the IBC mode of a dual tree, the chroma component reference block can be obtained based on the chroma block vector derived from the DBV mode. Additionally, in Implementation 2, reference signals can be obtained from the region holding pre-decoded adjacent samples.

### (Implementation 3) Cross-Component Discrete Mapping Model Based on the Template Matching Technique

As described above, the conventional CCDMM mode derives a discrete mapping model between luma and chroma in the reconstructed neighboring area where a linear model is applied, and uses the derived discrete mapping model to predict chroma samples from luma samples within the current block.

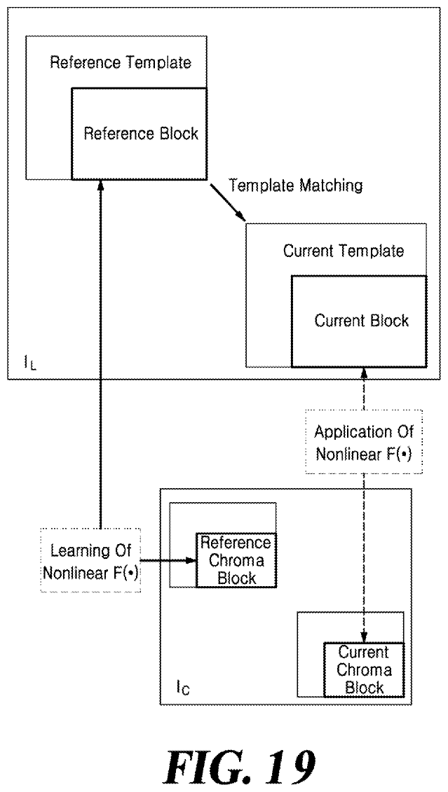

FIG. 19 is a diagram illustrating nonlinear modeling-based template matching prediction according to another embodiment of the present disclosure.

This implementation describes a template matching-based cross-component discrete mapping model. As illustrated in FIG. 19, during the derivation of the discrete mapping model, the video decoding apparatus according to the present disclosure derives the mapping relationship between luma and chroma within the reference block that is based on template matching and stores the derived mapping relationship. In the example of FIG. 19, I_{L} represents luma signals, and I_{C} represents chroma signals. Omitting the calculation of continuous functions, the discrete mapping model directly memorizes the luma-chroma pair from within the reference block obtained through template matching. The video decoding apparatus derives the chroma sample by referencing the luma value at the downsampled position of the current block based on the discrete mapping model. Namely, the cross-component discrete mapping model derived from within the reference block is applied between the luma signals and chroma signals of the current block. Downsampled from the luma-chroma pair, the luma value is equivalent to the input, and the chroma value is equivalent to the output. Hereafter, the set containing the luma-chroma pairs is defined as the mapping set of the discrete mapping model, or the discrete mapping set.

When the input to the mapping set of the discrete mapping model has no searchable Y_{c} which corresponds in position to the current block's chroma sample, the video decoding apparatus checks {Y_{c+1}, Y_{c-1}, Y_{c+2}, Y_{c-2}} in a predetermined random order as illustrated in FIG. 17. As described above, in the example of FIG. 17, c=3, i.e., Y_{c}=Y₃. In the example of FIG. 17, the samples represent the luma values at the current block's downsampled position. When the input to the discrete mapping set has no searchable ones of the five values, the video decoding apparatus sets the predicted value of the current chroma sample to a value calculated based on adjacent reconstructed chroma samples, which is, for example, an average value, a median value, or the like.

Implementation 3 relates to establishing a discrete mapping model between the luma signals and chroma signals of the current block, and it utilizes a reference block obtained via template matching as reference information to obtain information between the luma signals and chroma signals. When Implementation 3 is applied to the IBC mode of a single tree, the reference block may be obtained according to the existing block vector. Furthermore, when Implementation 3 is applied to the IBC mode of a dual tree, the chroma component reference block may be obtained based on the chroma block vector derived from the DBV mode. Additionally, in Implementation 3, the reference information may be obtained from the region where pre-decoded adjacent samples are located.

### (Implementation 4) Cross-Component Nonlinear Model Based on the Template Matching Technique

In this implementation, a template matching-based cross-component nonlinear model is derived. Instead of a template matching-based cross-component discrete mapping model, the video decoding apparatus derives a template matching-based cross-component nonlinear model. At this time, the above-described schemes of calculating the nonlinear model may be utilized. The video decoding apparatus implements the cross-component nonlinear model by using one of the following schemes.

For example, the video decoding apparatus derives a nonlinear function by applying the existing derivation technique of nonlinear models used in GLM, CCCM, and the lime, to the reference block. In other words, the video decoding apparatus derives and stores a nonlinear function representing the relationship between the luma signals and chroma signals of the reference block.

Alternatively, in addition to the existing derivation methods used in GLM, CCCM, and the like, the video decoding apparatus implements a nonlinear filter by using one of the following representation schemes, a part of one representation scheme, or a combination of the representation schemes.

To predict a chroma sample, the nonlinear filter according to this embodiment may be implemented as shown in Equation 15.

$${R}_{i} ( x , y ) = {\sum }_{( {x}_{0} , {y}_{0} ) ∈ {S}_{i}} \{ NM of {R}_{Y} ( {x}_{c} + {x}_{0} , {y}_{c} + {y}_{0} ) \} {c}_{i} ( {x}_{0} , {y}_{0} ) \qquad [ Equation 15 ]$$

In Equation 15, R_{Y} denotes the reconstructed luma sample, and Rᵢ (i∈{Cb, Cr}) denotes the predicted chroma sample. (x, y) denotes the position of the chroma sample, and (x_{c}, y_{c}) denotes the position of the luma sample corresponding to (x, y). (x₀, y₀) denotes the filter offset around (x_{c}, y_{c}), and Si denotes the target region for filtering for the reference samples. xᵢ(x₀, y₀) denotes the filter coefficient.

cᵢ(x₀, y₀) denotes the filter coefficient. The filter may be of various shapes and sizes. For example, a filter may be used with the same shape as the ALF filter illustrated in FIG. 18. In the example of FIG. 18, the C2 sample represents the luma sample co-located with the chroma sample to be filtered. As another example, a filter with the shape illustrated in FIG. 8 may be used. As yet another example, in addition to the nonlinear terms shown in Equation 10, the nonlinear filter may include linear terms as shown in Equation 7.

The nonlinear filter uses nonlinear modeling for the luma samples within the target region for filtering to generate nonlinear modeling values of the luma samples. Subsequently, the nonlinear filter may generate chroma sample values based on the product of the nonlinear modeling values and nonlinear filter coefficients.

At this time, one of the following schemes may be used for nonlinear modeling.

As one example, a nonlinear model may be implemented by using a polynomial function, as shown in Equation 16.

NM=αₙ·(R_{Y}(x_{c}+x₀,y_{c}+y₀)ⁿ+αₙ₋₁·(R_{Y}(x_{c}+x₀,y_{c}+y₀)ⁿ⁻¹+ . . . +α₁·(R_{Y}(x_{c}+x₀,y_{c}+y₀)+α₀ [Equation 16]

As another example, the Michaelis-Menten hyperbolic model may be used as shown in Equation 17.

$$NM = \frac{{R}_{Y} ( {x}_{c} + {x}_{0} , {y}_{c} + {y}_{0} ) + {α}_{0}}{1 + {α}_{1} + {R}_{Y} ( {x}_{c} + {x}_{0} , {y}_{c} + {y}_{0} )} \qquad [ Equation 17 ]$$

As yet another example, a model based on the Fourier transform, as shown in Equation 18, may be used.

NM=α₁ cos(R_{Y}(x_{c}+x₀,y_{c}+y₀)+α₀) [Equation 18]

As yet another example, an exponential function model may be used, as shown in Equation 19.

NM=e^{R}^{_{Y}}^{(x}^{_{c}}^{+x}^{₀}^{,y}^{_{c}}^{+y}^{₀}⁾+α₀ [Equation 19]

In Equation 16 through Equation 19, R_{Y} denotes the reconstructed luma sample. (x_{c}, y_{c}) denotes the position of the luma sample corresponding to the chroma sample position (x, y). (x₀, y₀) represents the filter offset around (x_{c}, y_{c}). Furthermore, αⱼ are parameters of the nonlinear model, which may be preset values according to the nonlinear model. For example, if the nonlinear model is a polynomial function like Equation 6, α₂ is 1 and α₀ is 512.

As an example, the video decoding apparatus sets, in the presented nonlinear modeling, R_{Y} and Rᵢ as the luma sample and chroma prediction sample of the template matching-based reference block, respectively. It then calculates the filter coefficients so as to minimize the MSE between the predicted value, e.g., according to Equation 15, and the chroma sample of the reference block. After deriving nonlinear filter coefficients, the video decoding apparatus predicts the current chroma block based on the derived nonlinear filter. By referencing the reconstructed luma sample values of the current block, the video decoding apparatus calculates the final predicted Ri based on the nonlinear filter.

Implementation 4 relates to a method of establishing a nonlinear relationship between the luma signals and chroma signals of the current block, and it utilizes a reference block obtained via template matching as reference information to obtain information between the luma signals and chroma signals. When Implementation 4 is applied to the IBC mode of a single tree, the reference block may be obtained based on the existing block vector. Furthermore, when Implementation 4 is applied to the IBC mode of a dual tree, the chroma component reference block may be obtained based on the chroma block vector derived from the DBV mode. Additionally, in Implementation 4, reference information may be obtained from the region where pre-decoded adjacent samples are located.

Meanwhile, when multiple types of filters are used in the template matching technique according to Implementation 1 to Implementation 4, the video decoding apparatus may use one of the following methods.

For example, after applying a linear model-based filter, a nonlinear filter may be applied. For instance, after applying a linear model-based filter, by applying a nonlinear model F(•), the video decoding apparatus calculates the current block as shown in Equation 20.

$${L}_{i}^{curr} = F ( {\sum }_{i = 0}^{N - 1} {α}_{i} \cdot {L}_{i}^{ref} + β ) \qquad [ Equation 20 ]$$

In Equation 20, Lᵢ^{curr} denotes the i-th luma sample of the current block, and Lᵢ^{ref} denotes the reference sample. αᵢ denotes the i-th coefficient of the linear model, and β denotes the offset. N denotes the number of luma samples involved in the linear filtering.

As another example shown in Equation 21, after applying a model G(•) based on the luma sample gradient, a nonlinear model F(•) may be applied.

C=F(α·G+β) [Equation 21]

In Equation 21, α and β represent the parameters implementing the GLM. The gradient G may be computed by using one pattern of a preset number of Sobel-based gradient patterns.

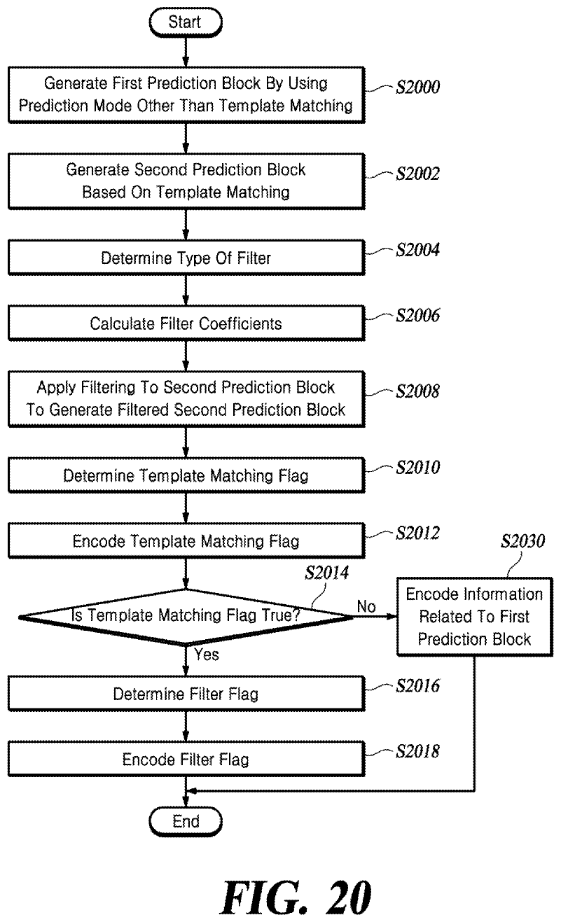

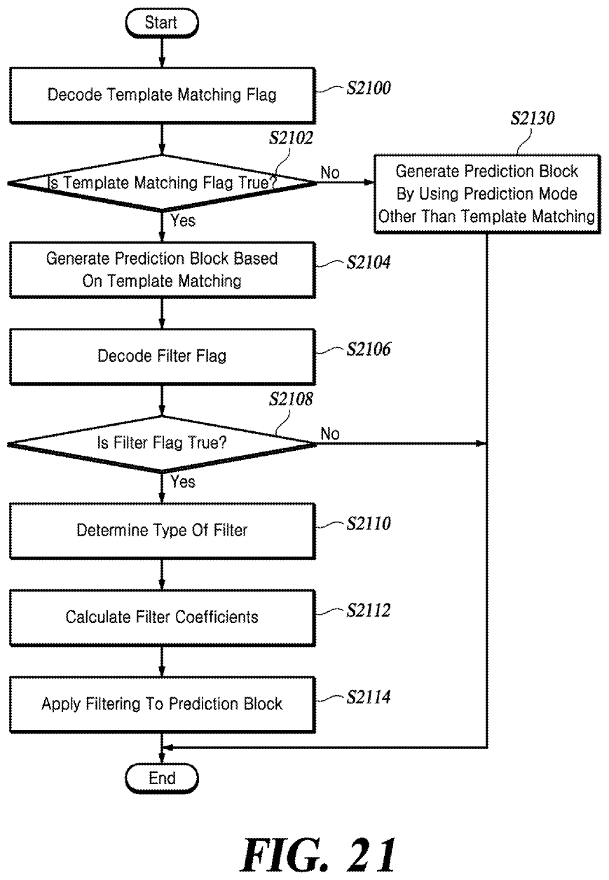

Hereinafter, by using the illustrations in FIGS. 20 and 21, methods of predicting the current block based on template matching are described.

FIG. 20 is a flowchart of a method of encoding the current block by the video encoding apparatus, according to at least one embodiment of the present disclosure.

The video encoding apparatus uses a prediction mode that does not utilize template matching to generate a first prediction block of the current block (S2000). For example, the video encoding apparatus may use an intra-prediction mode that does not use template matching, or may use an inter-prediction mode.

The video encoding apparatus obtains the size of the current block and determines whether the size satisfies the range conditions, e.g., minimum block size condition and/or maximum block size condition for encoding according to template matching-based prediction. If the range conditions are satisfied, the video encoding apparatus performs template matching-based prediction.

The video encoding apparatus generates a second prediction block of the current block based on template matching (S2002).

The video encoding apparatus predicts the current block by using template matching according to a preset order, e.g., z-scan order. The video encoding apparatus searches for a reference block based on template matching between the templates of blocks within the search region and the template of the current block, and uses the searched reference block to determine the second prediction block of the current block.

The video encoding apparatus determines the type of the filter (S2004).

The filter type may be a linear model, a discrete mapping model, or a nonlinear filter. Alternatively, the filter type may be a composite of a linear model and a nonlinear filter. The video encoding apparatus may determine the filter type from a rate-distortion optimization perspective. The video encoding apparatus encodes information indicating the filter type.

The video encoding apparatus calculates the filter coefficients (S2006).

For example, the video encoding apparatus derives the filter coefficients of the linear model by using a regression model that minimizes the MSE between the samples within the reference block's template and the samples within the current block's template. In another example, the video encoding apparatus computes a discrete mapping model or nonlinear filter between the reference block's template and the current block's template. In yet another example, the video encoding apparatus uses the luma signals and chroma signals of the reference block to calculate a cross-component discrete mapping model or a cross-component nonlinear filter.

The video encoding apparatus applies filtering to the second prediction block based on the filter to generate a filtered second prediction block (S2008).

For example, the video encoding apparatus generates the filtered second prediction block by applying a linear model to the reference block. Alternatively, the video encoding apparatus uses a discrete mapping model or nonlinear filter between templates to generate the filtered second prediction block from the reference block.

In another example, the video encoding apparatus uses a cross-component discrete mapping model or a cross-component nonlinear filter to predict the chroma signals of the second prediction block from the luma signals of the second prediction block (or the filtered second prediction block). Here, the luma signals of the prediction block (or the filtered prediction block) are assumed to be reconstructed.

The video encoding apparatus determines a template matching flag based on the first prediction block, the second prediction block, and the filtered second prediction block (S2010). Here, the template matching flag indicates whether template matching is used for the current block.

In terms of rate-distortion optimization, the video encoding apparatus determines the template matching flag. For example, if the first prediction block is optimal, the template matching flag is determined to be false. Conversely, if the second prediction block or the filtered second prediction block is optimal, the template matching flag is determined to be true.

The video encoding apparatus encodes the template matching flag (S2012).

The video encoding apparatus checks the template matching flag (S2014).

If the template matching flag is true (Yes in S2014), the video encoding apparatus performs the following steps.

The video encoding apparatus determines a filter flag based on the second prediction block and the filtered second prediction block (S2016). Here, the filter flag indicates the applicability of the filtering to the prediction block according to the template matching.

The video encoding apparatus determines the filter flag from a rate-distortion optimization perspective. For example, if the second prediction block is optimal, the filter flag is determined to be false. Conversely, if the filtered second prediction block is optimal, the filter flag is determined to be true.

The video encoding apparatus encodes the filter flag (S2018).

Furthermore, the video encoding apparatus encodes information indicating the type of the filter.

If the template matching flag is false (No in S2014), the video encoding apparatus encodes information related to the first prediction block (S2030).

Subsequently, the video encoding apparatus subtracts the prediction block, determined based on the template matching flag and filter flag, from the current block to generate a residual block. The video encoding apparatus then applies transform/quantization to the residual block to generate quantized transform coefficients, and encodes these quantized transform coefficients.

In the example of FIG. 20, the video encoding apparatus utilizes template matching in the process of obtaining a reference block. As another example, when IBC mode is applied in a single tree, the video encoding apparatus may obtain the reference block according to the existing block vector. When the IBC mode is applied in a dual tree, the video encoding apparatus may obtain the chroma component reference block based on the chroma block vector derived from the DBV mode. At this time, the template matching flag may be replaced with a flag indicating the application of the IBC mode.

FIG. 21 is a flowchart of a method of reconstructing the current block by the video decoding apparatus, according to at least one embodiment of the present disclosure.

The video decoding apparatus obtains the size of the current block and checks whether the size of the current block satisfies the range conditions, e.g., minimum block size condition and/or maximum block size condition for encoding according to template matching-based prediction.

When the size satisfies the range conditions, the video decoding apparatus decodes the template matching flag from the bitstream (S2100). The template matching flag indicates whether template matching is to be used for the current block.

The video decoding apparatus checks the template matching flag (S2102).

If the template matching flag is true (Yes in S2102), the video decoding apparatus performs the following steps.

The video decoding apparatus generates a prediction block of the current block based on template matching (S2104).

The video decoding apparatus predicts the current block by using template matching according to a preset order, e.g., z-scan order. The video decoding apparatus searches for a reference block based on template matching between the templates of blocks within the search region and the template of the current block, and determines that the prediction block of the current block is the searched reference block.

The video decoding apparatus decodes a filter flag from the bitstream (S2106). Here, the filter flag indicates the applicability of the filtering to the prediction block based on the template matching.

The video decoding apparatus checks the filter flag (S2108).

If the filter flag is true (Yes in S2108), the video decoding apparatus performs the following steps.

The video decoding apparatus obtains the type of the filter for the current block (S2110).

The type of the filter may be a linear model, a discrete mapping model, or a nonlinear filter. Alternatively, the type of the filter may be a composite of a linear model and a nonlinear filter. For example, to obtain the type of the filter, the video decoding apparatus may decode information indicating the type of the filter from the bitstream.

The video decoding apparatus calculates the filter coefficients (S2112).

As one example, the video decoding apparatus derives the filter coefficients of the linear model by using a regression model that minimizes the MSE between samples within the reference block's template and samples within the current block's template. In another example, the video decoding apparatus calculates a discrete mapping model or nonlinear filter between the reference block's template and the current block's template. In yet another example, the video decoding apparatus uses the luma signals and chroma signals of the reference block to calculate a cross-component discrete mapping model or cross-component nonlinear filter.

The video decoding apparatus uses the filter to apply filtering to the prediction block (S2114).

For example, the video decoding apparatus generates a filtered prediction block by applying the linear model to the reference block. In another example, the video decoding apparatus uses a discrete mapping model or nonlinear filter between templates to generate a filtered prediction block from the reference block.

In another example, the video decoding apparatus uses a cross-component discrete mapping model or a cross-component nonlinear filter to predict chroma signals of the prediction block from luma signals of the prediction block (or filtered prediction block). Here, the luma signals of the prediction block (or filtered prediction block) are assumed to be reconstructed.

If the filter flag is false (No in S2108), the video decoding apparatus does not perform filtering of the prediction block based on template matching.

If the range condition is not satisfied or the template matching flag is false (No in S2102), the video decoding apparatus uses a prediction mode other than template matching to generate the prediction block of the current block (S2130). For example, the video decoding apparatus may use an intra-prediction mode that does not use template matching, or use an inter-prediction mode.

Subsequently, the video decoding apparatus decodes the quantized transform coefficients and applies inverse quantization/inverse transform to the quantized transform coefficients to generate a residual block. The video decoding apparatus may sum the residual block and the prediction block to generate a reconstructed block of the current block.

In the example of FIG. 21, the video decoding apparatus utilizes template matching in the process of obtaining the reference block. As another example, when IBC mode is applied in a single tree, the video decoding apparatus may obtain the reference block according to the existing block vector. When the IBC mode is applied in a dual tree, the video decoding apparatus may obtain the chroma component reference block based on the chroma block vector derived from the DBV mode. At this time, the template matching flag may be replaced with a flag indicating the application of the IBC mode.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
155: entropy encoder
510: entropy decoder
542: intra predictor

### CROSS-REFERENCE TO RELATED APPLICATIONS

This application claims priority to and the benefit of Korean Patent Application No. 10-2023-0065621 filed on May 22, 2023, and Korean Patent Application No. 10-2024-0045374, filed on Apr. 3, 2024, the entire contents of each of which are incorporated herein by reference.

1. A method for reconstructing a current block by a video decoding apparatus, the method comprising:
searching for a reference block based on template matching between templates of blocks within a search region and a template of the current block, or based on a block vector of the current block, and determining a prediction block of the current block by using the searched reference block;
obtaining a type of a filter for the current block, the type of the filter comprising a cross-component discrete mapping model or a cross-component nonlinear filter;
calculating coefficients of the filter by using the reference block; and
applying filtering to the prediction block by using the filter.

2. The method of claim 1, further comprising:
decoding from a bitstream a template matching flag that indicates whether template matching is to be used for the current block; and
checking the template matching flag,
wherein, when the template matching flag is true, the method proceeds with determining the prediction block of the current block.

3. The method of claim 1, further comprising:
decoding a flag indicating whether an intra block copy mode (IBC mode) is to be applied; and
checking the flag,
wherein, when the flag is true, the method proceeds with determining the prediction block of the current block.

4. The method of claim 3, wherein determining the prediction block of the current block comprises:
when the IBC mode is applied in a single tree, determining luma samples and chroma samples of the reference block based on the block vector of the current block.

5. The method of claim 3, wherein determining the prediction block of the current block comprises:
when the IBC mode is applied in a dual tree, determining chroma samples of the reference block based on a chroma block vector derived from a direct block vector mode (DBV mode).

6. The method of claim 1, further comprising:
decoding from a bitstream a filter flag that indicates whether the filtering is to be applied to the prediction block; and
checking the filter flag,
wherein, when the flag true, the method proceeds with obtaining the type of the filter.

7. The method of claim 1, wherein calculating the coefficients of the filter comprises:
inputting luma samples of the reference block to the cross-component nonlinear filter; and
calculating the coefficients of the cross-component nonlinear filter so as to minimize a difference between an output of the cross-component nonlinear filter and a corresponding chroma sample within the reference block.

8. The method of claim 7, wherein applying the filtering comprises:
generating a filtered prediction sample of the chroma sample of the current block by applying the coefficients of the cross-component nonlinear filter to luma samples around a position corresponding to the chroma sample within a luma block of the current block.

9. The method of claim 1, wherein calculating the coefficients of the filter comprises:
deriving luma-chroma pairs representing a relationship between luma samples and chroma samples of the reference block; and
storing the luma-chroma pairs in a mapping set of the cross-component discrete mapping model.

10. The method of claim 9, wherein applying the filtering comprises:
generating a filtered chroma prediction sample of the current block from a luma sample obtained by downsampling the current block, based on the luma-chroma pairs of the cross-component discrete mapping model.

11. The method of claim 9, wherein applying the filtering comprises:
when an input to the mapping set has neither a searchable value of a luma sample corresponding in position to the chroma sample of the current block nor searchable values of neighboring samples of the luma sample, generating a filtered chroma prediction sample of the current block by a value calculated based on reconstructed chroma samples adjacent to the chroma sample.

12. A method for encoding a current block by a video encoding apparatus, the method comprising:
generating a first prediction block of the current block by using a prediction mode other than template matching and an intra block copy mode (IBC mode);
searching for a reference block based on template matching between templates of blocks within a search region and a template of the current block, or based on a block vector of the current block, and determining a second prediction block of the current block by using the searched reference block;
obtaining a type of a filter for the current block, the type of the filter comprising a cross-component discrete mapping model or a cross-component nonlinear filter;
calculating coefficients of the filter by using the reference block; and
generating a filtered second prediction block by applying filtering to the second prediction block by using the filter.

13. The method of claim 12, further comprising:
determining a template matching flag based on the first prediction block, the second prediction block, and the filtered second prediction block, the template matching flag indicating whether template matching is to be used for the current block;
encoding the template matching flag; and
checking the template matching flag.

14. A method of claim 13, further comprising, when the template matching flag is true:
determining, based on the second prediction block and the filtered second prediction block, a filter flag that indicates whether a filtering is to be applied to the prediction block;
encoding the filter flag; and
encoding information indicating the type of the filter.

15. The method of claim 12, further comprising:
determining a flag indicating whether the IBC mode is to be applied based on the first prediction block, the second prediction block, and the filtered second prediction block; and
encoding the flag.

16. A method for providing video data to a video decoding apparatus, the method comprising:
encoding the video data into a bitstream; and
transmitting the bitstream to the video decoding apparatus,
wherein the encoding of the video data comprises:
generating a first prediction block of a current block by using a prediction mode other than template matching and an intra block copy mode (IBC mode);
searching for a reference block based on template matching between templates of blocks within a search region and a template of the current block, or based on a block vector of the current block, and determining a second prediction block of the current block by using the searched reference block;
obtaining a type of a filter for the current block, the type of the filter comprising a cross-component discrete mapping model or a cross-component nonlinear filter;
calculating coefficients of the filter by using the reference block; and
generating a filtered second prediction block by applying filtering to the second prediction block by using the filter.
